(19) United States
(12) Patent Application Publication
(10) Pub. No.: US 2026/0081876 A1
(43) Pub. Date: Mar. 19, 2026

(54) DATA PROCESSING METHOD, NETWORK INTERFACE CARD, ELECTRONIC DEVICE, AND STORAGE MEDIUM

(71) Applicant: Beijing Youzhuju Network Technology Co., Ltd., Beijing (CN)

(72) Inventors: Layong LUO, Beijing (CN); Qingsong NING, Beijing (CN); Zilong WANG, Beijing (CN); Peng XIE, Beijing (CN); Tao FENG, Beijing (CN); Ke CHENG, Beijing (CN); Xiongfei GENG, Beijing (CN); Tianhao WANG, Beijing (CN); Weicheng LING, Beijing (CN); Kejia HUO, Beijing (CN); Pingbo AN, Beijing (CN); Kui JI, Beijing (CN); Shideng ZHANG, Beijing (CN); Bin XU, Beijing (CN); Ruiqing FENG, Beijing (CN); Tao DING, Beijing (CN); Jian WANG, Beijing (CN)

(21) Appl. No.: 19/103,524

(22) PCT Filed: Aug. 1, 2023
(86) PCT No.: PCT/CN2023/110522

§ 371 Date: Feb. 12, 2025

(30) Foreign Application Priority Data
Aug. 10, 2022 (CN) 202210957229.9

(51) Int. Cl. H04L 47/50; H04L 47/32; H04L 67/1097

(52) U.S. Cl. CPC H04L 47/54; H04L 47/32; H04L 67/1097

(57) ABSTRACT

A data processing method, a network interface card, an electronic device, and a storage medium. The method includes: determining a target dispatch queue to be dispatched from a host memory in response to a doorbell signal sent by a target host, where the doorbell signal indicates that there is a target message to be sent; determining a current target dispatch state of the target dispatch queue, where the target dispatch state is obtained based on an activity and a credit value corresponding to the target work queue element; determining whether a dispatch mechanism corresponding to the target dispatch queue is valid based on the target dispatch state, where the dispatch mechanism indicates whether the target dispatch queue is allowed to be dispatched; and performing a dispatch operation on the target work queue element and the target message in response to the dispatch mechanism being valid.

The present disclosure claims priority to Chinese Patent Application No. 202210957229.9, filed with the China National Intellectual Property Administration on Aug. 10, 2022 and entitled “DATA PROCESSING METHOD, NETWORK INTERFACE CARD, ELECTRONIC DEVICE, AND STORAGE MEDIUM”, which is incorporated herein by reference in its entirety.

### TECHNICAL FIELD

The present disclosure belongs to the field of communication technologies, and specifically relates to a data processing method, a network interface card, an electronic device, and a storage medium.

### BACKGROUND

Currently, much data is not stored locally but is stored in a remote data storage device. An existing data storage system mainly includes a data storage device, a host client, and a switch. The storage device is connected to the switch through a front-end network, and the switch is connected to at least one host client. The storage device may provide a data storage service for a plurality of host clients. The storage device includes a central processor and at least one network interface card.

During a data read process based on remote direct memory access (RDMA for short), a network interface card often blindly arranges a queue to perform scheduling. In addition, during the scheduling process, congestion control affects the queue, so that the scheduled queue does not obtain a number of message bytes allowed to be sent (that is, congestion control authorization is not obtained), resulting in failure in the scheduling this time and waste of the scheduling time, and degrading performance.

### SUMMARY

To solve the above technical problems or at least partially solve the above technical problems, the present disclosure provides a data processing method, a network interface card, an electronic device, and a storage medium.

According to an aspect of an embodiment of the present disclosure, a data processing method is provided. The method includes:
determining, in response to a doorbell signal sent by a target host, a target dispatch queue to be dispatched from a host memory, where the doorbell signal indicates that there is a target message to be sent in at least one target work queue element in the target dispatch queue;
determining a current target dispatch state of the target dispatch queue, where the target dispatch state is obtained based on an activity and a credit value corresponding to the target work queue element;
determining, based on the target dispatch state, whether a dispatch mechanism corresponding to the target dispatch queue is valid, where the dispatch mechanism indicates whether the target dispatch queue is allowed to be dispatched; and
performing a dispatch operation on the target work queue element and the target message in response to the dispatch mechanism being valid.

According to another aspect of the embodiment of the present disclosure, a network interface card is further provided. The network interface card includes a direct memory access engine module and a transmission module.

The direct memory access engine module is configured to determine, in response to a doorbell signal sent by a target host, a target dispatch queue to be dispatched from a host memory, where the doorbell signal indicates that there is a target message to be sent in at least one target work queue element in the target dispatch queue; determine a current target dispatch state of the target dispatch queue, where the target dispatch state is obtained based on an activity and a credit value corresponding to the target work queue element; and determine, based on the target dispatch state, whether a dispatch mechanism corresponding to the target dispatch queue is valid, where the dispatch mechanism indicates whether the target dispatch queue is allowed to be dispatched.

The transmission module is configured to perform a dispatch operation on the target work queue element and the target message in response to the dispatch mechanism being valid.

According to another aspect of the embodiment of the present disclosure, a computer-readable storage medium is further provided. The storage medium includes a stored program that, when run, performs the above steps.

According to another aspect of the embodiment of the present disclosure, an electronic device is further provided. The electronic device includes a processor, a communication interface, a memory, a communication bus, and the above network interface card.

An embodiment of the present disclosure further provides a computer program product including instructions. When the computer program product runs on a computer, the computer is caused to perform the steps in the above method.

Compared with the prior art, the technical solution provided in the embodiments of the present disclosure has the following advantages: In the method provided in the embodiments of the present disclosure, after the target dispatch queue to be dispatched is determined based on the doorbell signal sent by the target host, the target dispatch state of the target dispatch queue is first determined based on the activity and the credit value corresponding to the target work queue element in the target dispatch queue. Then, whether the dispatch mechanism corresponding to the target dispatch queue is valid is determined based on target dispatch state, and whether the target dispatch queue can be subsequently dispatched is determined based on whether the dispatch mechanism is valid. In this way, whether the dispatch mechanism is valid is determined through the dispatch state before queue dispatch, so that it is effectively ensured that each dispatch of the send queue can be effectively performed. Compared with the prior art, there is no need for blind dispatch, so that the success rate of queue dispatch is improved, unnecessary dispatch time is avoided, and the service performance of the network interface card is enhanced.

### BRIEF DESCRIPTION OF THE DRAWINGS

Figures are used to provide a further understanding of the present invention, and constitute a part of the specification. Together with the embodiments of the present invention, they are used to explain the present invention, but do not constitute a limitation on the present invention. In the figures:

FIG. 1 is a flowchart of a data processing method according to an embodiment of the present disclosure;

FIG. 2 is a schematic diagram of a target host according to an embodiment of the present disclosure;

FIG. 3 is a flowchart of a data processing method according to another embodiment of the present disclosure;

FIG. 4 is a schematic diagram of a queue dispatch process according to an embodiment of the present disclosure;

FIG. 5 is a flowchart of a data processing method according to another embodiment of the present disclosure;

FIG. 6 is a flowchart of a data processing method according to another embodiment of the present disclosure;

FIG. 7 is a schematic diagram of a data packet retransmission according to an embodiment of the present disclosure;

FIG. 8 is a block diagram of a network interface card according to another embodiment of the present disclosure; and

FIG. 9 is a schematic structural diagram of an electronic device according to an embodiment of the present disclosure.

### DETAILED DESCRIPTION

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. It is apparent that the described embodiments are some rather than all of the embodiments of the present disclosure. The schematic embodiments of the present disclosure and the description thereof are used to explain the present disclosure and do not constitute an improper limitation of the present disclosure. All other embodiments obtained by a person of ordinary skill in the art based on the embodiments of the present disclosure without creative efforts shall fall within the protection scope of the present disclosure.

It should be noted that in this specification, relational terms such as “first” and “second” are only used to distinguish one entity or operation from another similar entity or operation, but do not necessarily require or imply any actual relationship or order between these entities or operations. Moreover, the terms “include”, “comprise”, or any other variant thereof are intended to cover a non-exclusive inclusion, so that a process, method, article, or device that includes a list of elements includes not only those elements, but also other elements not explicitly listed, or further includes elements inherent to the process, method, article, or device. Without more restrictions, an element defined by a statement “including a/an . . . ” does not exclude the presence of another same element in the process, method, article, or device that includes the element.

The embodiments of the present disclosure provide a data processing method, a data storage device, and a network interface card. The method provided in the embodiments of the present disclosure may be applied to any required electronic device, for example, may be an electronic device such as a server or a terminal. This is not specifically limited. For ease of description, the electronic device is hereinafter simply referred to as an electronic device.

According to an aspect of an embodiment of the present disclosure, a method embodiment for a data processing method is provided. FIG. 1 is a flowchart of a data processing method according to an embodiment of the present disclosure. As shown in FIG. 1, the method includes the following steps.

Step S11: Determine, in response to a doorbell signal sent by a target host, a target dispatch queue to be dispatched from a host memory, where the doorbell signal indicates that there is a target message to be sent in at least one target work queue element in the target dispatch queue.

The method provided in the embodiments of the present disclosure is applied to a network interface card in a data storage device. The network interface card (RDMA network interface card, RNIC for short) is implemented based on remote direct memory access (RDMA for short). The network interface card is connected to the target host by using a communication bus.

In the target host, a queue pair (QP for short) is used to send and receive data (as a message) of a requestor. Each QP includes a send queue (SQ for short) and a receive queue (RQ for short). The SQ is responsible for sending a message, and the RQ is responsible for receiving the message. The SQ and the RQ of each QP may be respectively associated with one completion queue (CQ for short).

In the application scenario of the embodiments of the present disclosure, there are a plurality of send queues in the target host. Each of the plurality of send queues includes at least one work queue element, and each work queue element is associated with at least one message. For example, when there is a new work queue element (that is, the target work queue element) in a send queue and there is a message to be sent in storage space pointed to by the target work queue element, the target host automatically triggers the doorbell signal, and sends the doorbell signal to the network interface card.

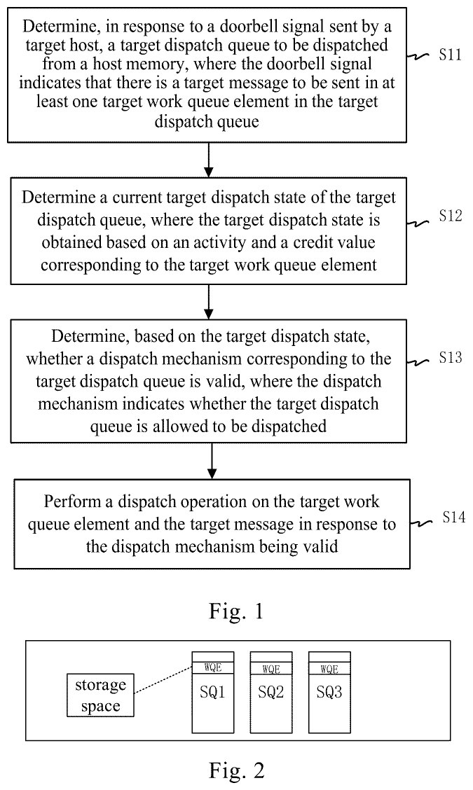

Referring to FIG. 2, FIG. 2 is a schematic diagram of a target host according to an embodiment of the present disclosure. As shown in FIG. 2, the target host includes a plurality of send queues SQ1, SQ2, SQ3, and SQ4. When there is a target message to be sent in storage space pointed to by one target work queue element (Work Queue Element, WQE for short) in the SQ1, the target host sends the doorbell signal to the network interface card. The storage space is located in a buffer.

In the embodiments of the present disclosure, the network interface card determines, in response to the doorbell signal sent by the target host, the target dispatch queue to be dispatched from the plurality of send queues in the host memory.

Step S12: Determine a current target dispatch state of the target dispatch queue, where the target dispatch state is obtained based on an activity and a credit value corresponding to the target work queue element.

In the embodiments of the present disclosure, after determining the target dispatch queue, the network interface card first queries the activity and the credit value corresponding to the target work queue element in the target dispatch queue, and determines the current target dispatch state of the target dispatch queue based on the activity and the credit value. Specifically, if the activity is greater than or equal to a preset activity and the credit value is greater than or equal to a preset credit value, it is determined that the target dispatch state of the target dispatch queue is a dispatch ready state. If the activity is less than the preset activity, and/or the credit value is less than the preset credit value, it is determined that the target dispatch state of the target dispatch queue is a dispatch suspended state.

Step S13: Determine, based on the target dispatch state, whether a dispatch mechanism corresponding to the target dispatch queue is valid, where the dispatch mechanism indicates whether the target dispatch queue is allowed to be dispatched.

In the embodiments of the present disclosure, before whether the dispatch mechanism corresponding to the target dispatch queue is valid can be determined based on the target dispatch state, target dispatch information corresponding to the target dispatch queue is first generated. The target dispatch information includes a target dispatch serial number and the target dispatch state, and the target dispatch serial number is obtained based on a trigger time of the doorbell signal.

For example, if the target dispatch state is the dispatch ready state and the target dispatch serial number is less than or equal to a preset dispatch serial number, it is determined that the dispatch mechanism corresponding to the target dispatch queue is valid. If the target dispatch state is the dispatch ready state and the target dispatch serial number is greater than the preset dispatch serial number, it is determined that the dispatch mechanism corresponding to the target dispatch queue is not valid.

Step S14: Perform a dispatch operation on the target work queue element and the target message in response to the dispatch mechanism being valid.

In the embodiments of the present disclosure, if the dispatch mechanism is valid, the network interface card moves the target work queue element and the target message of the target dispatch queue from the host memory, and performs the dispatch operation on the target work queue element and the target message.

In the embodiments of the present disclosure, if the dispatch serial number is greater than the preset dispatch serial number, it is determined whether there is a priority for the target dispatch queue. If there is a priority for the target dispatch queue, the dispatch operation on the target work queue element and the target message is performed based on the priority; or if there is no priority for the target dispatch queue, the dispatch operation on the target work queue element and the target message is performed in an order in a preset dispatch list.

In the method provided in the embodiments of the present disclosure, after the target dispatch queue to be dispatched is determined based on the doorbell signal sent by the target host, the target dispatch state of the target dispatch queue is first determined based on the activity and the credit value corresponding to the target work queue element in the target dispatch queue. Then, whether the dispatch mechanism corresponding to the target dispatch queue is valid is determined based on the target dispatch state, and whether the target dispatch queue can be subsequently dispatched is determined based on whether the dispatch mechanism is valid. In this way, whether the dispatch mechanism is valid is determined through the dispatch state before queue dispatch, so that it is effectively ensured that each dispatch of the send queue can be effectively performed. Compared with the prior art, there is no need for blind dispatch, so that the success rate of queue dispatch is improved, unnecessary dispatch time is avoided, and the service performance of the network interface card is enhanced.

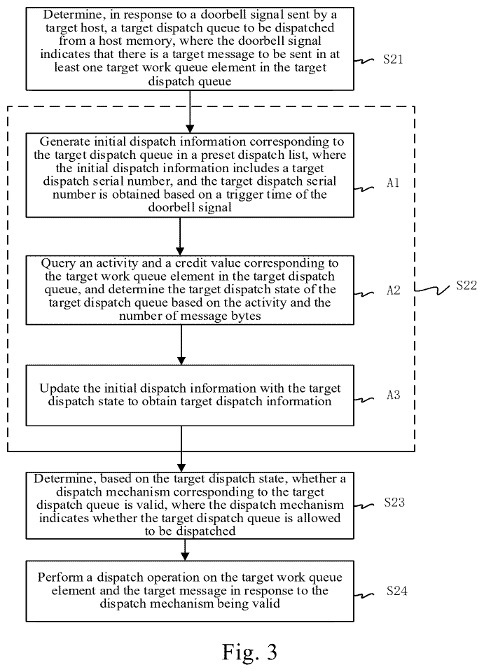

According to an aspect of an embodiment of the present disclosure, an embodiment of a method for a data processing method is provided. FIG. 3 is a flowchart of a data processing method according to an embodiment of the present disclosure. As shown in FIG. 3, the method includes the following steps.

Step S21: Determine, in response to a doorbell signal sent by a target host, a target dispatch queue to be dispatched from a host memory, where the doorbell signal indicates that there is a target message to be sent in at least one target work queue element in the target dispatch queue.

For details, please refer to the related description corresponding to the above embodiment. Details are not described herein again.

Step S22: Determine a current target dispatch state of the target dispatch queue, where the target dispatch state is obtained based on an activity and a credit value corresponding to the target work queue element.

In the embodiments of the present disclosure, step S22, determining a current target dispatch state of the target dispatch queue, includes the following steps A1 to A3.

Step A1: Generate initial dispatch information corresponding to the target dispatch queue in a preset dispatch list, where the initial dispatch information includes a target dispatch serial number, and the target dispatch serial number is obtained based on a trigger time of the doorbell signal.

In the embodiments of the present disclosure, after determining the target dispatch queue based on the doorbell signal, the network interface card determines the target dispatch serial number of the target dispatch sequence in the preset dispatch list based on the trigger time of the doorbell signal, and generates the initial dispatch information of the target dispatch queue. For example, the initial dispatch information is QP1: active0, credit0, ready0, in which active is used to indicate an activity corresponding to a work queue element, credit is used to indicate whether a message corresponding to the work queue element obtains a number of message bytes allowed to be sent, that is, whether the message is authorized to be sent, and 0 is an initial value corresponding to each parameter.

Step A2: Query an activity and a credit value corresponding to the target work queue element in the target dispatch queue, and determine the target dispatch state of the target dispatch queue based on the activity and the number of message bytes.

In the embodiments of the present disclosure, the network interface card may obtain the activity corresponding to the target work queue element from the target host, and may further query the credit value of the target work queue element from a congestion control center arranged inside the network interface card. The credit value is used to indicate whether a target message corresponding to the target work queue element obtains a number of message bytes allowed to be sent. It should be noted that when the credit value of the target work queue element is queried through the congestion control center, if there is a credit value, the number of message bytes allowed to be sent by the target message corresponding to the target work queue element is also obtained.

In the embodiments of the present disclosure, the target dispatch state includes: a dispatch ready state and a dispatch suspended state. Specifically, determining the target dispatch state of the target dispatch queue based on the activity and the number of message bytes includes: in response to the activity being greater than or equal to a preset activity and the credit value being greater than or equal to a preset credit value, determining that the target dispatch state of the target dispatch queue is the dispatch ready state; or in response to the activity being less than the preset activity, and/or the credit value being less than the preset credit value, determining that the target dispatch state of the target dispatch queue is the dispatch suspended state.

In the embodiments of the present disclosure, to facilitate quick confirmation of the target dispatch state of the target dispatch queue, a first identifier is first determined based on the activity, and a second identifier is determined based on whether there is the number of message bytes allowed to be sent. Then, a third identifier is determined based on a preset correspondence and the first identifier and the second identifier, and the third identifier is used to indicate the target dispatch state.

In the embodiments of the present disclosure, if the queried activity is greater than or equal to the preset activity, the first identifier corresponding to the activity is “1”, and if the queried activity is less than the preset activity, the first identifier corresponding to the activity is “0”. If the queried number of message bytes allowed to be sent is greater than or equal to a preset number of message bytes, the second identifier corresponding to the number of message bytes allowed to be sent is “1”, and if the queried number of message bytes allowed to be sent is less than the preset number of message bytes, the second identifier corresponding to the number of message bytes allowed to be sent is “0”.

When the first identifier is 1 and the second identifier is 1, the third identifier is 1, indicating that the target dispatch state is the dispatch ready state. When the first identifier is 0 and/or the second identifier is 0, the third identifier is 0, indicating that the target dispatch state is the dispatch suspended state.

Step A3: Update the initial dispatch information with the target dispatch state to obtain target dispatch information.

In the embodiments of the present disclosure, after obtaining the target dispatch state, the target dispatch state is written into the initial dispatch information, that is, the update of the initial dispatch information is completed. For example, the third identifier is written into the initial dispatch information, and the obtained target dispatch information is: QP1: active1, credit1, ready1.

Step S23: Determine, based on the target dispatch state, whether a dispatch mechanism corresponding to the target dispatch queue is valid, where the dispatch mechanism indicates whether the target dispatch queue is allowed to be dispatched. For details, please refer to the related description corresponding to the above embodiment. Details are not described herein again.

Step S24: Perform a dispatch operation on the target work queue element and the target message in response to the dispatch mechanism being valid. The preset number is a maximum number of messages that can be obtained in this dispatch. For details, please refer to the related description corresponding to the above embodiment. Details are not described herein again.

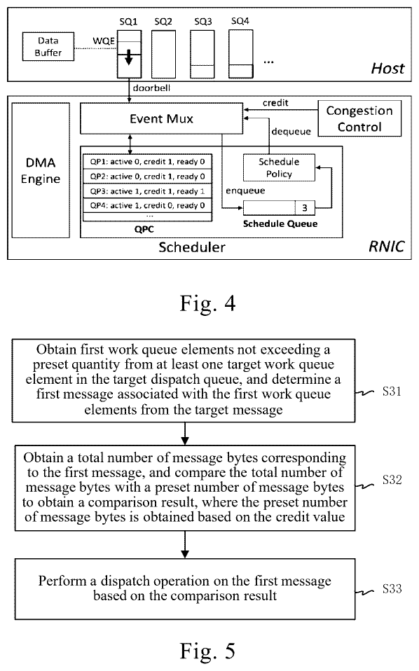

Referring to FIG. 4, FIG. 4 is a schematic diagram of a queue dispatch process according to an embodiment of the present disclosure. As an example, as shown in FIG. 4, the target dispatch queue SQ1 in the target host sends the doorbell signal to the network interface card. An event manager (Event Mux) in the network interface card queries the credit value from the congestion control center (Congestion Control), and queries the activity of the work queue element from the target host, and then writes the credit value and the activity into a preset dispatch list, to determine a target dispatch state corresponding to the target dispatch queue in the preset dispatch list. If the event manager (Event Mux) determines, based on the target dispatch state in target dispatch information, that the dispatch mechanism corresponding to the target dispatch queue is valid, the event manager (Event Mux) performs a dispatch operation on the target work queue element and the target message.

In the embodiments of the present disclosure, the target dispatch information of the target dispatch queue is generated in the preset dispatch list, and whether the target dispatch queue can be dispatched can be quickly determined through the target dispatch state and the target dispatch serial number in the target dispatch information. In addition, for a queue that cannot meet a dispatch mechanism, the dispatch information corresponding to the queue can be deleted in time, so that the dispatch efficiency is effectively ensured.

FIG. 5 is a flowchart of a data processing method according to an embodiment of the present disclosure. As shown in FIG. 5, performing the dispatch operation on the work queue element and the message to be sent includes the following steps.

Step S31: Obtain first work queue elements not exceeding a preset quantity from at least one target work queue element in the target dispatch queue, and determine a first message associated with the first work queue elements from the target message.

In the embodiments of the present disclosure, because a round-trip delay of a peripheral component interconnect express (Peripheral Component Interconnect express, PCIe for short) is high and because two PCIe transmissions are required for each dispatch, the communication performance and effect are poor without reasonable design.

Based on this, in the embodiments of the present disclosure, n work queue elements are obtained from at least one target work queue element in the target dispatch queue as the first work queue elements, where n is a maximum number of messages that can be obtained in this dispatch. Then, a first message associated with the first work queue elements is determined from the target message, so that the target work queue element is obtained by using a bufferless method, without the need to pre-fetch and buffer the work queue element, thereby improving the scalability of the network interface card.

Step S32: Obtain a total number of message bytes corresponding to the first message, and compare the total number of message bytes with a preset number of message bytes to obtain a comparison result, where the preset number of message bytes is obtained based on the credit value.

In the embodiments of the present disclosure, after the first message to be sent is determined, the total number of message bytes corresponding to the first message is obtained, and the total number of message bytes is compared with the preset number of message bytes to obtain the comparison result. It should be noted that the preset number of message bytes is used to maximize message sending by using limited memory of the network interface card. It should be noted that because there are tens of thousands of queues in the central processing unit and the memory of the network interface card is very limited, when a congestion occurs, it cannot be guaranteed that messages in each send queue can be completely sent, and the performance of the network interface card is also degraded.

Step S33: Perform a dispatch operation on the first message based on the comparison result.

In the embodiments of the present disclosure, performing the dispatch operation on the first message based on the comparison result includes the following steps B1 and B2.

Step B1: Encapsulate the first message to obtain a first data packet in response to the comparison result indicating that the total number of message bytes is less than or equal to the preset number of message bytes.

Step B2: Send the first data packet to a recipient device.

In the embodiments of the present disclosure, if the comparison result indicates that the total number of message bytes is less than or equal to the preset number of message bytes, it indicates that the message currently to be sent in the target dispatch queue can be completely sent. In this case, the network interface card encapsulates the first message to be sent to obtain the first data packet, and sends the first data packet to the recipient device.

It should be noted that because the first message includes a plurality of consecutive message contents, in the process of encapsulating the first message, the network interface card writes the plurality of message contents into a plurality of data packets and sends the data packets separately, and at the same time, modifies a RoCEv2 header of each data packet. Specifically, the network interface card queries a storage address of each message in the host memory, generates a consecutive packet serial number based on the storage address, and then encapsulates the consecutive packet serial number into the RoCEv2 header to obtain the final first data packet. In this way, the storage address of the message to be sent is encapsulated in the RoCEv2 header in the form of the packet serial number, so that it is convenient to determine a corresponding order of each data packet during remote data access. In addition, during subsequent retransmission, the data packet to be retransmitted can be directly located based on a retransmission requirement.

In the embodiments of the present disclosure, performing the dispatch operation on the first message based on the comparison result includes the following steps C1 to C3:

Step C1: Obtain, from the first message, a second message to be sent and having a preset number of bytes in response to the comparison result indicating that the total number of message bytes is greater than the preset number of message bytes.

Step C2: Encapsulate the second message to be sent to obtain a second data packet.

Step C3: Send the second data packet to a recipient device, and discard a remaining unencapsulated message in the first message.

In the embodiments of the present disclosure, if the comparison result indicates that the total number of message bytes is greater than the preset number of message bytes, it indicates that the message currently to be sent in the target dispatch queue cannot be completely sent. The second message is obtained from the first message based on the preset number of message bytes, and then the second message is encapsulated to obtain the second data packet.

It should be noted that because the second message includes a plurality of consecutive message contents, in the process of encapsulating the second message, the network interface card writes the plurality of message contents into a plurality of data packets and sends the data packets separately, and at the same time, modifies a RoCEv2 header of each data packet. Specifically, the network interface card queries a storage address of each message in the host memory, generates a consecutive packet serial number based on the storage address, and then encapsulates the consecutive packet serial number into the RoCEv2 header to obtain the final second data packet. In this way, the storage address of the message to be sent is encapsulated in the RoCEv2 header in the form of the packet serial number, so that it is convenient to determine a corresponding order of each data packet during remote data access. In addition, during subsequent retransmission, the data packet to be retransmitted can be directly located based on a retransmission requirement.

As an example, the network interface card first queries a queue address of the target dispatch queue in the host memory, and then moves a plurality of target work queue elements based on the queue address, obtains n first work queue elements from the target work queue elements, and determines a first message corresponding to the n first work queue elements, where a total number of message bytes corresponding to the first message is m. The total number of message bytes m is compared with the preset number of message bytes burst_size. If m is less than or equal to burst_size, the first message is directly encapsulated to obtain a first data packet and the first data packet is sent. If m is greater than burst_size, the second message is obtained from the total number of message bytes m based on the preset number of message bytes burst_size, and the second message is encapsulated to obtain a second data packet and the second data packet is sent.

It should be noted that there are two key parameters: n and burst_size. n is a maximum number of work queue elements that can be currently obtained, and burst_size is the number of message bytes allowed to be obtained in each dispatch iteration. In the embodiments of the present disclosure, n is used to reflect a balance between PCIe bandwidth usage and PCIe latency hiding. If the value of n is too small, it is indeed possible to bring about better bandwidth usage in the PCIe fetch-and-drop strategy, but PCIe latency cannot be hidden. If the value of n is large, the opposite situation occurs. Based on this analysis, the embodiments of the present disclosure set n to 8 to balance the PCIE bandwidth utilization and latency hiding.

For burst_size, it can reflect a balance between PCIe bandwidth usage and frequency, and head-of-line blocking. A smaller burst_size can achieve finer dispatch granularity, thereby reducing head-of-line blocking, but saturates PCIe bandwidth. A larger burst_size is opposite to the above situation. Based on this analysis, the embodiments of the present disclosure set the value of burst_size to 16 KB to take into account performance and dispatch granularity.

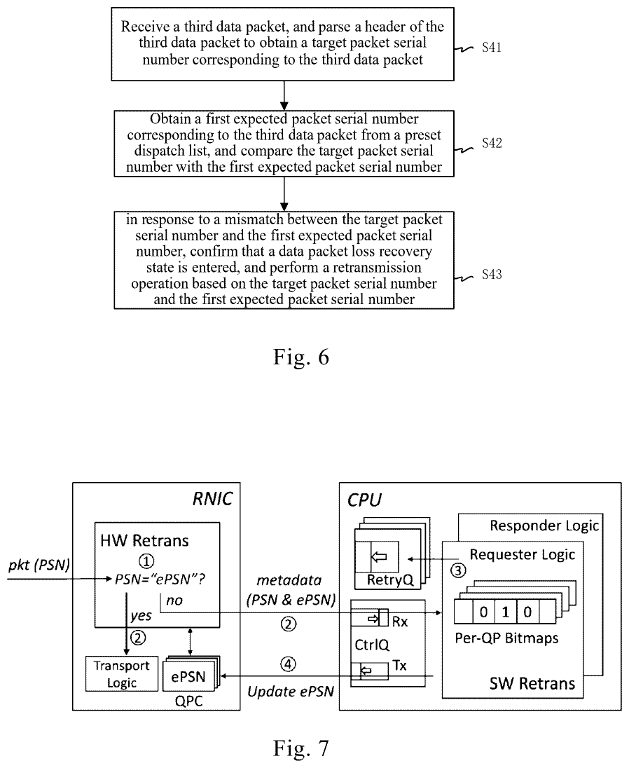

Referring to FIG. 6, FIG. 6 is a flowchart of a data processing method according to another embodiment of the present disclosure. In the embodiments of the present disclosure, after performing a dispatch operation on the target work queue element and the target message corresponding to the target work queue element, as shown in FIG. 6, the method further includes the following steps.

Step S41: Receive a third data packet, and parse a header of the third data packet to obtain a target packet serial number corresponding to the third data packet.

In the embodiments of the present disclosure, after receiving the third data packet, the network interface card parses the third data packet, and extracts the target packet serial number corresponding to the third data packet from the header of the third data packet.

Step S42: Obtain a first expected packet serial number corresponding to the third data packet from a preset dispatch list, and compare the target packet serial number with the first expected packet serial number.

In the embodiments of the present disclosure, the network interface card obtains the first expected packet serial number corresponding to the third data packet from the preset dispatch list, and then compares the first expected packet serial number with the target packet serial number. It should be noted that the preset dispatch list stores expected packet serial numbers corresponding to a plurality of data packets.

As an example, the preset dispatch list stores expected packet serial numbers: A-003, B-002, and C-006. A-003 represents an expected packet serial number of a third data packet corresponding to message A, B-002 represents an expected packet serial number of a second data packet corresponding to message B, and C-006 represents an expected packet serial number of a sixth data packet corresponding to message C. In this case, a target packet serial number obtained from the header of the third data packet is “B-004”. In a case where the first expected packet serial number corresponding to the third data packet is “B-002”, the target packet serial number “B-004” is compared with the first expected packet serial number “B-002”.

Step S43: in response to a mismatch between the target packet serial number and the first expected packet serial number, confirm that a data packet loss recovery state is entered, and perform a retransmission operation based on the target packet serial number and the first expected packet serial number.

In the embodiments of the present disclosure, performing the retransmission operation based on the target packet serial number and the first expected packet serial number includes the following steps D1 and D2.

Step D1: Send the target packet serial number and the first expected packet serial number to a central processor of the target host, to cause the central processor to obtain a packet serial number corresponding to a lost data packet from a bitmap based on the target packet serial number and the first expected packet serial number.

Step D2: Receive a retransmission request sent by the central processor, and send the retransmission request to a sender corresponding to the third data packet, where the retransmission request is generated based on the packet serial number corresponding to the lost data packet and sent through a target retransmission queue, and the target retransmission queue is a retransmission queue corresponding to a send queue associated with the lost data packet.

In the embodiments of the present disclosure, if the target packet serial number does not match the first expected packet serial number, it indicates that there is currently a packet loss. In this case, the network interface card enters the data packet loss recovery state, and sends the target packet serial number and the first expected packet serial number to the central processor of the target host.

In the embodiments of the present disclosure, the central processor of the target host updates a bitmap corresponding to a message to which the third data packet belongs based on the target packet serial number and the first expected packet serial number, and queries, from the updated bitmap, a packet serial number corresponding to a currently lost data packet. The bitmap stores reception states of a plurality of data packets corresponding to the message to which the third data packet belongs. Then, a retransmission request is generated based on the packet serial number corresponding to the lost data packet, and a target retransmission queue corresponding to a send queue associated with the lost data packet/the third data packet is queried. Finally, the retransmission request is sent to the target retransmission queue, and the retransmission request is sent through the target retransmission queue.

In the embodiments of the present disclosure, after receiving the retransmission request sent by the central processor of the target host, the network interface card directly sends the retransmission request to a sender device corresponding to the third data packet.

As an example, it is assumed that a target packet serial number of the third data packet is “B-004”,and the first expected packet serial number is “B-002”. In this case, the updated bitmap includes: “1, 0, 0, 1”. The first “1” indicates that the first data packet corresponding to the message is successfully received, the second “0” indicates that the second data packet corresponding to the message is not successfully received, the third “0” indicates that the third data packet corresponding to the message is not successfully received, and the fourth “1” indicates that the fourth data packet corresponding to the message is successfully received. Based on this, it can be determined that packet serial numbers of the lost data packets are “B-002” and “B-003”. Then, a target retransmission queue corresponding to a send queue associated with the lost data packets is queried, and the retransmission request generated based on the packet serial numbers of the lost data packets is sent to the target retransmission queue, so that the target retransmission queue sends the retransmission request.

In the embodiments of the present disclosure, after the target packet serial number and the first expected packet serial number are sent to the target host, the method further includes the following steps E1 and E2.

Step E1: Receive a fourth data packet, and in response to a packet serial number carried in the fourth data packet being consistent with the packet serial number corresponding to the lost data packet, send the fourth data packet to the target host.

Step E2: Receive a second expected packet serial number sent by the target host, and write the second expected packet serial number into the preset dispatch list, where the second expected packet serial number is sent by the target host after receiving the fourth data packet.

In the embodiments of the present disclosure, after sending the retransmission request to the sender device corresponding to the third data packet, the network interface card listens to whether the sender device corresponding to the third data packet sends a fourth data packet. When receiving the fourth data packet, the network interface card parses the fourth data packet to obtain a packet serial number corresponding to the fourth data packet, and compares the packet serial number of the fourth data packet with the packet serial number corresponding to the lost data packet. If the packet serial number carried in the fourth data packet is consistent with the packet serial number corresponding to the lost data packet, it is determined that the lost data packet is recovered. In this case, the fourth data packet is sent to the central processor of the target host, and the network interface card cancels the data packet loss recovery state.

In the embodiments of the present disclosure, after receiving the fourth data packet, the central processor determines, based on the packet serial number of the fourth data packet, that the lost data packet is retrieved, and correspondingly updates the bitmap. Then, the central processor sends the second expected packet serial number to the network interface card, where the second expected packet serial number is a serial number of a next data packet corresponding to a currently received data packet. After receiving the second expected packet serial number, the network interface card writes a second expected data packet into the preset dispatch list, and waits for receiving the corresponding data packet.

Referring to FIG. 7, FIG. 7 is a schematic diagram of a data packet retransmission according to an embodiment of the present disclosure. As an example, a data packet retransmission process is shown in FIG. 7.
(1) After receiving a data packet, the network interface card parses the data packet to obtain a packet serial number (PSN) carried in the data packet, and obtains, from a preset dispatch list, an expected packet serial number (e PSN) corresponding to the data packet.
(2) The packet serial number is compared with the expected packet serial number. If the two are consistent, the data packet is directly sent to a central processor of a target host for normal processing, for example, the data packet is stored in a receive queue.
(3) If the two are inconsistent, it is determined that there is a packet loss. In this case, the packet serial number and the expected packet serial number are sent to the central processor of the target host. The central processor determines a packet serial number corresponding to a currently lost data packet from a bitmap (Per QP bitmaps) based on the packet serial number and the expected packet serial number, generates a retransmission request based on the packet serial number corresponding to the lost data packet, sends the retransmission request to a retransmission queue (Retry Q), transmits the retransmission request to the network interface card through the retransmission queue, and the network interface card sends the retransmission request.
(4) After sending the retransmission request, if the network interface card receives a new data packet, the network interface card determines whether a packet serial number of the new data packet is consistent with the packet serial number of the lost data packet. If the two are consistent, it is determined that the lost data packet is retrieved. In this case, the new data packet is sent to the central processor of the target host.
(5) After receiving the new data packet, the central processor sends a new expected packet serial number to the network interface card based on a packet serial number of the new data packet.

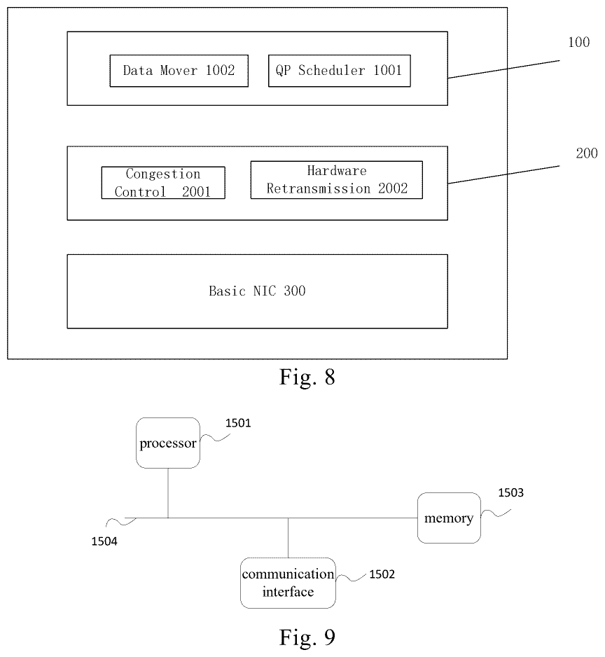

Referring to FIG. 8, FIG. 8 is a block diagram of a network interface card according to another embodiment of the present disclosure. As shown in FIG. 8, the embodiments of the present disclosure further provide a network interface card. The network interface card includes: a direct memory access engine module 100 and a transmission module 200.

The direct memory access engine module 100 is configured to determine, in response to a doorbell signal sent by a target host, a target dispatch queue to be dispatched from a host memory, where the doorbell signal indicates that there is a target message to be sent in at least one target work queue element in the target dispatch queue; determine a current target dispatch state of the target dispatch queue, where the target dispatch state is obtained based on an activity and a credit value corresponding to the target work queue element; and determine, based on the target dispatch state, whether a dispatch mechanism corresponding to the target dispatch queue is valid, where the dispatch mechanism indicates whether the target dispatch queue is allowed to be dispatched.

The transmission module 200 is configured to perform a dispatch operation on the target work queue element and the target message in response to the dispatch mechanism being valid.

In the embodiments of the present disclosure, the direct memory access engine module 100 is configured to determine that the target dispatch state of the target dispatch queue is a dispatch ready state in response to the activity being greater than or equal to a preset activity and the credit value being greater than or equal to a preset credit value; or the direct memory access engine module 100 is configured to determine that the target dispatch state of the target dispatch queue is a dispatch suspended state in response to the activity being less than the preset activity, and/or the credit value being less than the preset credit value.

In the embodiments of the present disclosure, the direct memory access engine module 100 includes: a scheduler 1001; and the scheduler 1001 is configured to generate target dispatch information corresponding to the target dispatch queue, where the target dispatch information includes a target dispatch serial number and the target dispatch state, and the target dispatch serial number is obtained based on a trigger time of the doorbell signal.

In the embodiments of the present disclosure, the scheduler 1001 is configured to determine that the dispatch mechanism is valid if the target dispatch state is the dispatch ready state and the target dispatch serial number is less than or equal to a preset dispatch serial number, where the preset dispatch serial number is used to indicate a dispatch upper limit of the network interface card.

In the embodiments of the present disclosure, the direct memory access engine module 100 further includes: a data mover 1002; and the data mover 1002 is configured to obtain first work queue elements not exceeding a preset quantity from at least one target work queue element in the target dispatch queue, and determine a first message associated with the first work queue elements from the target message, obtain a total number of message bytes corresponding to the first message, and compare the total number of message bytes with a preset number of message bytes to obtain a comparison result, where the preset number of message bytes is obtained based on the credit value. The transmission module 200 is configured to perform a dispatch operation on the first message based on the comparison result.

In the embodiments of the present disclosure, the transmission module 200 is configured to encapsulate the first message to obtain a first data packet in response to the comparison result indicating that the total number of message bytes is less than or equal to the preset number of message bytes; and send the first data packet to a recipient device.

In the embodiments of the present disclosure, the data mover 1002 is configured to obtain, from the first message in response to the comparison result indicating that the total number of message bytes is greater than the preset number of message bytes, a second message to be sent and having a preset number of bytes. The transmission module 200 is configured to encapsulate the second message to be sent to obtain a second data packet; send the second data packet to a recipient device, and discard remaining unencapsulated messages in the first message.

In the embodiments of the present disclosure, the transmission module 200 includes: a retransmission module 2002, configured to receive a third data packet, and parse a header of the third data packet to obtain a target packet serial number corresponding to the third data packet; obtain a first expected packet serial number corresponding to the third data packet from a preset dispatch list, and compare the target packet serial number with the first expected packet serial number; and in response to a mismatch between the target packet serial number and the first expected packet serial number, confirm that a data packet loss recovery state is entered, and perform a retransmission operation based on the target packet serial number and the first expected packet serial number.

In the embodiments of the present disclosure, the retransmission module 2002 is specifically configured to send the target packet serial number and the first expected packet serial number to a central processor of the target host, to cause the central processor to obtain a packet serial number corresponding to a lost data packet from a bitmap based on the target packet serial number and the first expected packet serial number; and receive a retransmission request sent by the central processor, and send the retransmission request to a sender corresponding to the third data packet, where the retransmission request is generated based on the packet serial number corresponding to the lost data packet and sent through a target retransmission queue, and the target retransmission queue is a retransmission queue corresponding to a send queue associated with the lost data packet.

In the embodiments of the present disclosure, the retransmission module 2002 is configured to receive a fourth data packet, and in response to a packet serial number carried in the fourth data packet being consistent with the packet serial number corresponding to the lost data packet, send the fourth data packet to the target host; and receive a second expected packet serial number sent by the target host, and write the second expected packet serial number into the preset dispatch list, where the second expected packet serial number is sent by the target host after receiving the fourth data packet.

The network interface card provided in the embodiments of the present disclosure first determines the target dispatch state of the target dispatch queue based on the activity and the credit value corresponding to the target work queue element in the target dispatch queue after determining the target dispatch queue to be dispatched based on the doorbell signal sent by the target host; and then determines whether the dispatch mechanism corresponding to the target dispatch queue is valid by using the target dispatch state; and determines whether the target dispatch queue can be subsequently dispatched based on whether the dispatch mechanism is valid. In this way, whether the dispatch mechanism is valid is determined through the dispatch state before queue dispatch, so that it is effectively ensured that each dispatch of the send queue can be effectively performed. Compared with the prior art, there is no need for blind dispatch, so that the success rate of queue dispatch is improved, unnecessary dispatch time is avoided, and the service performance of the network interface card is enhanced.

The embodiments of the present disclosure further provide an electronic device. Referring to FIG. 9, FIG. 9 is a schematic diagram of a structure of an electronic device according to an embodiment of the present disclosure. As shown in FIG. 9, the electronic device may include: a processor 1501, a communication interface 1502, a memory 1503, and a communication bus 1504, where the processor 1501, the communication interface 1502, and the memory 1503 complete mutual communication through the communication bus 1504.

The memory 1503 is configured to store a computer program.

The processor 1501 is configured to, when executing the computer program stored in the memory 1503, implement the steps in the above embodiments.

The communication bus mentioned in the terminal may be a Peripheral Component Interconnect (PCI) bus, an Extended Industry Standard Architecture (EISA) bus, or the like. The communication bus may be classified into an address bus, a data bus, a control bus, and the like. For ease of representation, only one thick line is used in the figure, but it does not mean that there is only one bus or one type of bus.

The communication interface is configured to communicate between the terminal and another device.

The memory may include a random access memory (RAM), and may further include a non-volatile memory (non-volatile memory), for example, at least one magnetic disk memory. Optionally, the memory may further be at least one storage apparatus located away from the foregoing processor.

The processor may be a general-purpose processor, including a central processing unit (CPU), a network processor (NP), and the like; may also be a digital signal processor (DSP), an application specific integrated circuit (ASIC), a field programmable gate array (FPGA), or another programmable logical device, a discrete gate or transistor logic device, or a discrete hardware component.

In another embodiment provided in the present disclosure, a computer-readable storage medium is further provided. The computer-readable storage medium stores an instruction, and when the instruction is run on a computer, the computer is enabled to perform the data processing method according to any one of the above embodiments.

In another embodiment provided in the present disclosure, a computer program product containing an instruction is further provided. When the computer program product runs on a computer, the computer is enabled to perform the data processing method according to any one of the above embodiments.

In the above embodiments, all or some may be implemented by using software, hardware, firmware, or any combination thereof. When the software is used to implement the embodiments, all or some of the embodiments may be implemented in a form of a computer program product. The computer program product includes one or more computer instructions. When the computer program instructions are loaded and executed on a computer, all or some of the processes or functions according to the embodiments of the present disclosure are generated. The computer may be a general-purpose computer, a dedicated computer, a computer network, or another programmable apparatus. The computer instructions may be stored in a computer-readable storage medium or may be transmitted from one computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive), or the like.

According to one or more embodiments of the present disclosure, Example 1 provides a data processing method, including:
determining, in response to a doorbell signal sent by a target host, a target dispatch queue to be dispatched from a host memory, where the doorbell signal indicates that there is a target message to be sent in at least one target work queue element in the target dispatch queue;
determining a current target dispatch state of the target dispatch queue, where the target dispatch state is obtained based on an activity and a credit value corresponding to the target work queue element;
determining, based on the target dispatch state, whether a dispatch mechanism corresponding to the target dispatch queue is valid, where the dispatch mechanism indicates whether the target dispatch queue is allowed to be dispatched; and
performing a dispatch operation on the target work queue element and the target message in response to the dispatch mechanism being valid.

Further, determining the current target dispatch state of the target dispatch queue includes:
in response to the activity being greater than or equal to a preset activity and the credit value being greater than or equal to a preset credit value, determining that the target dispatch state of the target dispatch queue is a dispatch ready state; or
in response to the activity being less than the preset activity, and/or the credit value being less than the preset credit value, determining that the target dispatch state of the target dispatch queue is a dispatch suspended state.

Further, after the target dispatch state is determined, the method further includes:
generating target dispatch information corresponding to the target dispatch queue, where the target dispatch information includes a target dispatch serial number and the target dispatch state, and the target dispatch serial number is obtained based on a trigger time of the doorbell signal.

Further, the dispatch mechanism is determined to be valid when the target dispatch state is the dispatch ready state and the target dispatch serial number is less than or equal to a preset dispatch serial number, where the preset dispatch serial number is used to indicate a dispatch upper limit of the network interface card.

Further, performing the dispatch operation on the target work queue element and the target message includes:
obtaining first work queue elements not exceeding a preset quantity from at least one target work queue element in the target dispatch queue, and determining a first message associated with the first work queue elements from the target message;
obtaining a total number of message bytes corresponding to the first message, and comparing the total number of message bytes with a preset number of message bytes to obtain a comparison result, where the preset number of message bytes is obtained based on the credit value; and
performing a dispatch operation on the first message based on the comparison result.

Further, performing the dispatch operation on the first message based on the comparison result includes:
in response to the comparison result indicating that the total number of message bytes is less than or equal to the preset number of message bytes, encapsulating the first message to obtain a first data packet; and
sending the first data packet to a recipient device.

Further, performing the dispatch operation on the first message based on the comparison result includes:
in response to the comparison result indicating that the total number of message bytes is greater than the preset number of message bytes, obtaining, from the first message, a second message to be sent and having a preset number of bytes;
encapsulating the second message to be sent to obtain a second data packet; and
sending the second data packet to a recipient device, and discarding remaining unencapsulated messages in the first message.

Further, after performing the dispatch operation on the target work queue element and the target message, the method further includes:
receiving a third data packet, and parsing a header of the third data packet to obtain a target packet serial number corresponding to the third data packet;
obtaining a first expected packet serial number corresponding to the third data packet from a preset dispatch list, and comparing the target packet serial number with the first expected packet serial number; and
in response to a mismatch between the target packet serial number and match the first expected packet serial number, confirming that a data packet loss recovery state is entered, and performing a retransmission operation based on the target packet serial number and the first expected packet serial number.

Further, performing the retransmission operation based on the target packet serial number and the first expected packet serial number includes:
sending the target packet serial number and the first expected packet serial number to a central processor of the target host, to cause the central processor to obtain a packet serial number corresponding to a lost data packet from a bitmap based on the target packet serial number and the first expected packet serial number; and
receiving a retransmission request sent by the central processor, where the retransmission request is generated based on the packet serial number corresponding to the lost data packet and sent through a target retransmission queue, and the target retransmission queue is a retransmission queue corresponding to a send queue associated with the lost data packet.

Further, after the target packet serial number and the first expected packet serial number are sent to the central processor, the method further includes:
receiving a fourth data packet, and in response to a packet serial number carried in the fourth data packet being consistent with the packet serial number corresponding to the lost data packet, sending the fourth data packet to the central processor; and
receiving a second expected packet serial number sent by the central processor, and writing the second expected packet serial number into the preset dispatch list, where the second expected packet serial number is sent by the central processor after receiving the fourth data packet.

According to one or more embodiments of the present disclosure, Example 2 provides a network interface card. The network interface card includes: a direct memory access engine module and a transmission module.

The direct memory access engine module is configured to determine, in response to a doorbell signal sent by a target host, a target dispatch queue to be dispatched from a host memory, where the doorbell signal indicates that there is a target message to be sent in at least one target work queue element in the target dispatch queue; determine a current target dispatch state of the target dispatch queue, where the target dispatch state is obtained based on an activity and a credit value corresponding to the target work queue element; and determine, based on the target dispatch state, whether a dispatch mechanism corresponding to the target dispatch queue is valid, where the dispatch mechanism indicates whether the target dispatch queue is allowed to be dispatched; and

The transmission module is configured to perform a dispatch operation on the target work queue element and the target message in response to the dispatch mechanism being valid.

Further, the direct memory access engine module is configured to determine that the target dispatch state of the target dispatch queue is a dispatch ready state in response to the activity being greater than or equal to a preset activity and the credit value being greater than or equal to a preset credit value; or the direct memory access engine module is configured to determine that the target dispatch state of the target dispatch queue is a dispatch suspended state in response to the activity being less than the preset activity, and/or the credit value being less than the preset credit value.

Further, the direct memory access engine module includes: a scheduler; and the scheduler is configured to generate target dispatch information corresponding to the target dispatch queue, where the target dispatch information includes a target dispatch serial number and the target dispatch state, and the target dispatch serial number is obtained based on a trigger time of the doorbell signal.

Further, the scheduler is configured to determine that the dispatch mechanism is valid if the target dispatch state is the dispatch ready state and the target dispatch serial number is less than or equal to a preset dispatch serial number, where the preset dispatch serial number is used to indicate a dispatch upper limit of the network interface card.

Further, the direct memory access engine module further includes: a data mover; and the data mover is configured to obtain first work queue elements not exceeding a preset quantity from at least one target work queue element in the target dispatch queue, and determine a first message associated with the first work queue elements from the target message, obtain a total number of message bytes corresponding to the first message, and compare the total number of message bytes with a preset number of message bytes to obtain a comparison result, where the preset number of message bytes is obtained based on the credit value. The transmission module is configured to perform a dispatch operation on the first message based on the comparison result.

Further, the transmission module is configured to encapsulate the first message to obtain a first data packet in response to the comparison result indicating that the total number of message bytes is less than or equal to the preset number of message bytes; and send the first data packet to a recipient device.

Further, the data mover is configured to obtain, from the first message in response to the comparison result indicating that the total number of message bytes is greater than the preset number of message bytes, a second message to be sent and having a preset number of bytes. The transmission module is configured to encapsulate the second message to be sent to obtain a second data packet; send the second data packet to a recipient device, and discard remaining unencapsulated messages in the first message.

Further, the transmission module includes: a retransmission module, configured to receive a third data packet, and parse a header of the third data packet to obtain a target packet serial number corresponding to the third data packet; obtain a first expected packet serial number corresponding to the third data packet from a preset dispatch list, and compare the target packet serial number with the first expected packet serial number; and in response to a mismatch between the target packet serial number and the first expected packet serial number, confirm that a data packet loss recovery state is entered, and perform a retransmission operation based on the target packet serial number and the first expected packet serial number.

Further, the retransmission module is specifically configured to send the target packet serial number and the first expected packet serial number to a central processor of the target host, to cause the central processor to obtain a packet serial number corresponding to a lost data packet from a bitmap based on the target packet serial number and the first expected packet serial number; and receive a retransmission request sent by the central processor, and send the retransmission request to a sender corresponding to the third data packet, where the retransmission request is generated based on the packet serial number corresponding to the lost data packet and sent through a target retransmission queue, and the target retransmission queue is a retransmission queue corresponding to a send queue associated with the lost data packet.

Further, the retransmission module is configured to receive a fourth data packet, and in response to a packet serial number carried in the fourth data packet being consistent with the packet serial number corresponding to the lost data packet, send the fourth data packet to the target host; and receive a second expected packet serial number sent by the target host, and write the second expected packet serial number into the preset dispatch list, where the second expected packet serial number is sent by the target host after receiving the fourth data packet.

The foregoing descriptions are merely preferred embodiments of the present disclosure, and are not intended to limit the scope of protection of the present disclosure. Any modifications, equivalent replacements, improvements, etc. made within the spirit and principle of the present disclosure shall fall within the scope of protection of the present disclosure.

The foregoing descriptions are merely specific implementations of the present disclosure, so that a person skilled in the art can understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to the embodiments shown herein, but is to comply with the widest scope consistent with the principles and novel features disclosed herein.

1. A data processing method, comprising:
determining, in response to a doorbell signal sent by a target host, a target dispatch queue to be dispatched from a host memory, wherein the doorbell signal indicates that there is a target message to be sent in at least one target work queue element in the target dispatch queue;
determining a current target dispatch state of the target dispatch queue, wherein the target dispatch state is obtained based on an activity and a credit value corresponding to the target work queue element;
determining, based on the target dispatch state, whether a dispatch mechanism corresponding to the target dispatch queue is valid, wherein the dispatch mechanism indicates whether the target dispatch queue is allowed to be dispatched; and
performing a dispatch operation on the target work queue element and the target message in response to the dispatch mechanism being valid.

2. The method according to claim 1, wherein the determining the current target dispatch state of the target dispatch queue comprises:
in response to the activity being greater than or equal to a preset activity and the credit value being greater than or equal to a preset credit value, determining that the target dispatch state of the target dispatch queue is a dispatch ready state; or
in response to the activity being less than the preset activity, and/or the credit value being less than the preset credit value, determining that the target dispatch state of the target dispatch queue is a dispatch suspended state.

3. The method according to claim 1, wherein after the determining the current target dispatch state of the target dispatch queue, the method further comprises:
generating target dispatch information corresponding to the target dispatch queue, wherein the target dispatch information comprises a target dispatch serial number and the target dispatch state, and the target dispatch serial number is obtained based on a trigger time of the doorbell signal.

4. The method according to claim 3, wherein the dispatch mechanism is determined to be valid when the target dispatch state is a dispatch ready state and the target dispatch serial number is less than or equal to a preset dispatch serial number, wherein the preset dispatch serial number is used to indicate a dispatch upper limit of the network interface card.

5. The method according to claim 1, wherein the performing the dispatch operation on the target work queue element and the target message comprises:
obtaining first work queue elements not exceeding a preset quantity from at least one target work queue element in the target dispatch queue, and determining a first message associated with the first work queue elements from the target message;
obtaining a total number of message bytes corresponding to the first message, and comparing the total number of message bytes with a preset number of message bytes to obtain a comparison result, wherein the preset number of message bytes is obtained based on the credit value; and
performing a dispatch operation on the first message based on the comparison result.

6. The method according to claim 5, wherein the performing the dispatch operation on the first message based on the comparison result comprises:
in response to the comparison result indicating that the total number of message bytes is less than or equal to the preset number of message bytes, encapsulating the first message to obtain a first data packet; and
sending the first data packet to a recipient device.

7. The method according to claim 6, wherein the performing the dispatch operation on the first message based on the comparison result comprises:
in response to the comparison result indicating that the total number of message bytes is greater than the preset number of message bytes, obtaining, from the first message, a second message to be sent and having a preset number of bytes;
encapsulating the second message to be sent to obtain a second data packet; and
sending the second data packet to a recipient device, and discarding a remaining unencapsulated message in the first message.

8. The method according to claim 1, wherein after the performing the dispatch operation on the target work queue element and the target message, the method further comprises:
receiving a third data packet, and parsing a header of the third data packet to obtain a target packet serial number corresponding to the third data packet;
obtaining a first expected packet serial number corresponding to the third data packet from a preset dispatch list, and comparing the target packet serial number with the first expected packet serial number; and
in response to a mismatch between the target packet serial number and the first expected packet serial number, confirming that a data packet loss recovery state is entered, and performing a retransmission operation based on the target packet serial number and the first expected packet serial number.

9. The method according to claim 8, wherein the performing the retransmission operation based on the target packet serial number and the first expected packet serial number comprises:
sending the target packet serial number and the first expected packet serial number to a central processor of the target host, to cause the central processor to obtain a packet serial number corresponding to a lost data packet from a bitmap based on the target packet serial number and the first expected packet serial number; and
receiving a retransmission request sent by the central processor, and sending the retransmission request to a sender corresponding to the third data packet, wherein the retransmission request is generated based on the packet serial number corresponding to the lost data packet and sent through a target retransmission queue, and the target retransmission queue is a retransmission queue corresponding to a send queue associated with the lost data packet.

10. The method according to claim 9, wherein after sending the target packet serial number and the first expected packet serial number to the central processor, the method further comprises:
receiving a fourth data packet, and in response to a packet serial number carried in the fourth data packet being consistent with the packet serial number corresponding to the lost data packet, sending the fourth data packet to the central processor; and
receiving a second expected packet serial number sent by the central processor, and writing the second expected packet serial number into the preset dispatch list, wherein the second expected packet serial number is sent by the central processor after receiving the fourth data packet.

11. A network interface card, comprising: a direct memory access engine module and a transmission module;
the direct memory access engine module is configured to determine, in response to a doorbell signal sent by a target host, a target dispatch queue to be dispatched from a host memory, wherein the doorbell signal indicates that there is a target message to be sent in at least one target work queue element in the target dispatch queue; determine a current target dispatch state of the target dispatch queue, wherein the target dispatch state is obtained based on an activity and a credit value corresponding to the target work queue element; and determine, based on the target dispatch state, whether a dispatch mechanism corresponding to the target dispatch queue is valid, wherein the dispatch mechanism indicates whether the target dispatch queue is allowed to be dispatched; and
the transmission module is configured to perform a dispatch operation on the target work queue element and the target message in response to the dispatch mechanism being valid.

12. The network interface card according to claim 11, wherein the direct memory access engine module comprises: a scheduler; and
the scheduler is configured to generate target dispatch information corresponding to the target dispatch queue, wherein the target dispatch information comprises a target dispatch serial number and the target dispatch state, and the target dispatch serial number is obtained based on a trigger time of the doorbell signal.

13. The network interface card according to claim 12, wherein
the scheduler is configured to determine that the dispatch mechanism is valid when the target dispatch state is a dispatch ready state and the target dispatch serial number is less than or equal to a preset dispatch serial number, wherein the preset dispatch serial number is used to indicate a dispatch upper limit of the network interface card.

14. The network interface card according to claim 13, wherein the direct memory access engine module further comprises: a data mover; and
the data mover is configured to obtain first work queue elements not exceeding a preset quantity from at least one target work queue element in the target dispatch queue, and determine a first message associated with the first work queue elements from the target message, obtain a total number of message bytes corresponding to the first message, and compare the total number of message bytes with a preset number of message bytes to obtain a comparison result, wherein the preset number of message bytes is obtained based on the credit value;
the transmission module is configured to perform a dispatch operation on the first message based on the comparison result.

15. An electronic device, comprising a processor, a communication interface, a memory, a communication bus, and a network interface card, wherein the network interface card comprises: a direct memory access engine module and a transmission module;
the direct memory access engine module is configured to determine, in response to a doorbell signal sent by a target host, a target dispatch queue to be dispatched from a host memory, wherein the doorbell signal indicates that there is a target message to be sent in at least one target work queue element in the target dispatch queue; determine a current target dispatch state of the target dispatch queue, wherein the target dispatch state is obtained based on an activity and a credit value corresponding to the target work queue element; and determine, based on the target dispatch state, whether a dispatch mechanism corresponding to the target dispatch queue is valid, wherein the dispatch mechanism indicates whether the target dispatch queue is allowed to be dispatched; and
the transmission module is configured to perform a dispatch operation on the target work queue element and the target message in response to the dispatch mechanism being valid.

16. A computer-readable storage medium, wherein the storage medium comprises a stored program, and when the program runs, steps of the method according to claim 1 are performed.

17. The network interface card according to claim 14, wherein the transmission module is configured to encapsulate the first message to obtain a first data packet in response to the comparison result indicating that the total number of message bytes is less than or equal to the preset number of message bytes; and send the first data packet to a recipient device.

18. The network interface card according to claim 17, wherein the data mover is configured to obtain, from the first message, a second message to be sent and having a preset number of bytes in response to the comparison result indicating that the total number of message bytes is greater than the preset number of message bytes;
the transmission module is configured to encapsulate the second message to be sent to obtain a second data packet; and send the second data packet to a recipient device, and discarding a remaining unencapsulated message in the first message.

19. The network interface card according to claim 11, further comprises a retransmission module, configured to:
receive a third data packet, and parsing a header of the third data packet to obtain a target packet serial number corresponding to the third data packet;
obtain a first expected packet serial number corresponding to the third data packet from a preset dispatch list, and comparing the target packet serial number with the first expected packet serial number; and
in response to a mismatch between the target packet serial number and the first expected packet serial number, confirm that a data packet loss recovery state is entered, and perform a retransmission operation based on the target packet serial number and the first expected packet serial number.

20. The network interface card according to claim 19, wherein the retransmission module is configured to:
send the target packet serial number and the first expected packet serial number to a central processor of the target host, to cause the central processor to obtain a packet serial number corresponding to a lost data packet from a bitmap based on the target packet serial number and the first expected packet serial number; and
receive a retransmission request sent by the central processor, and sending the retransmission request to a sender corresponding to the third data packet, wherein the retransmission request is generated based on the packet serial number corresponding to the lost data packet and sent through a target retransmission queue, and the target retransmission queue is a retransmission queue corresponding to a send queue associated with the lost data packet.
